(19) United States
(12) Patent Application Publication
(10) Pub. No.: US 2020/0121532 A1
(43) Pub. Date: Apr. 23, 2020

(54) Private and Portable Lift and Changing Station

(71) Applicant: Delynn Adair, Auburn, WA (US)

(72) Inventor: Delynn Adair, Auburn, WA (US)

(21) Appl. No.: 16/165,487

(22) Filed: Oct. 19, 2018

(51) Int. Cl. A61G 7/10; A47D 5/00; E04H 15/24; E04H 15/02

(52) U.S. Cl. CPC A61G 7/1001; A47D 5/006; A61G 7/1074; E04H 15/02; A61G 7/1046; E04H 15/24; A61G 7/1051

(57) ABSTRACT

The current invention is a private and portable changing station conveniently folds to fit inside a small cart with wheels to pull along behind a wheelchair. The changing system for handicapped adults and children is complete with a collapsible table, a Hoyer lift and privacy curtain. All the components are compactly stored within the portable cart and can be quickly set up. The Hoyer lift and privacy curtain are set up on a tripod stand. The table is pulled apart so that the top becomes flat and all of the legs lock into place underneath the lift.

### CROSS-REFERENCES TO RELATED APPLICATIONS (IF ANY)

None.

### BACKGROUND

### 1. Field of the Invention

This invention relates to a lift and changing station and particularly to one that provides privacy.

### 2. Description of Prior Art

Changing handicapped adults and children in wheelchairs can be difficult especially in public or while traveling. Trying to find a bathroom or location can be difficult if not impossible. There are not convenient bathrooms with enough space or privacy. Without fixing this need a handicapped adult or child will have to stay close to home or to miss out on all the life has to offer.

There is still room for improvement in the art.

### SUMMARY OF THE INVENTION

The current invention is a private and portable changing station conveniently folds to fit inside a small cart with wheels to pull along behind a wheelchair. The changing system is for handicapped adults and children is complete with a collapsible table, a Hoyer lift and privacy curtain so that no matter where a handicapped person is that person will have the privacy and comfort that they need. No more need to stay close to home or to miss out on all the life has to offer.

The private changing station is easy to use and perfect to take along for any occasion. All the components are compactly stored within the portable cart and can be quickly set up. The Hoyer lift and privacy curtain are set up on a tripod stand so all that need done is to pull the three legs apart where the changing station is to be assembled. Then the table simply has to be pulled apart so that the top becomes flat and all of the legs lock into place underneath the lift. It creates the perfect, comfortable and private changing station with plenty of space.

### BRIEF DESCRIPTION OF THE DRAWINGS

Without restricting the full scope of this invention, the preferred form of this invention is illustrated in the following drawings:

FIG. 1 shows the changing device set up;

FIG. 2 shows the changing device with the cover;

FIG. 3 shows the base holding the lift;

FIG. 4 shows the lift lowered for use;

FIG. 5 shows the device lifting a handicap person;

FIG. 6 shows the lift.

### DESCRIPTION OF THE PREFERRED EMBODIMENT

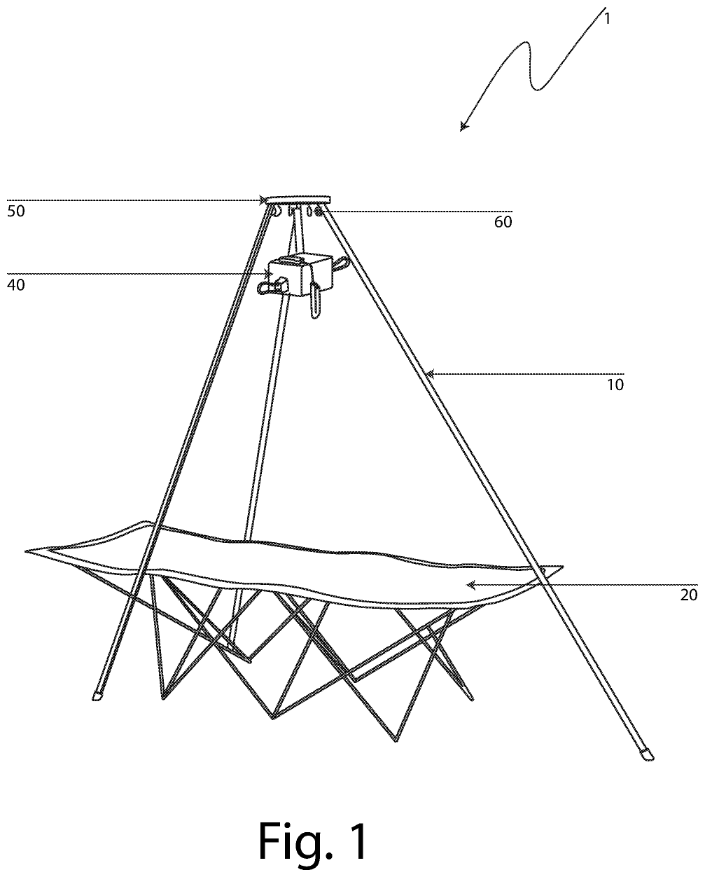

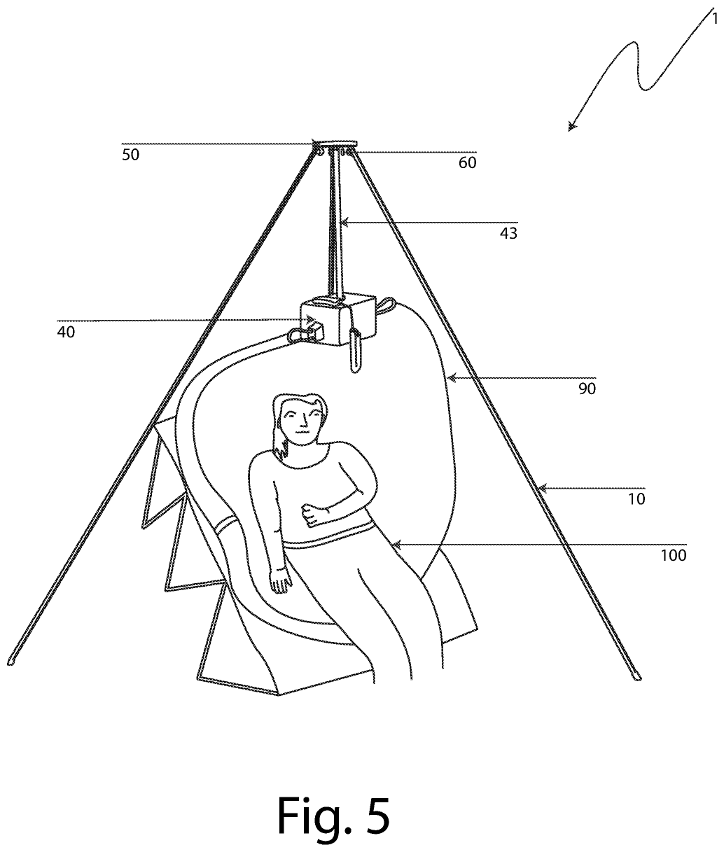

As shown in FIGS. 1 through 6, the current invention is a private and portable changing station 1 that conveniently folds to fit inside a small cart 90 with wheels 95 to pull along behind a wheelchair. The changing system 1 for handicapped adults and children is complete with a collapsible table 20, a Hoyer lift 40 and privacy curtain 70.

The private changing station 1 in the current invention is easy to use and perfect to take along for any occasion. All the components are compactly stored within carries placed on the portable cart 90 and can be quickly set up.

The Hoyer lift 40 and privacy curtain 70 are set up on a base which is a tripod stand 50 so all you have to do is pull the three legs 10 apart to assemble the changing station 1 as shown in FIG. 1. Then the table 20 simply has to be pulled apart so that the top becomes flat and all of the legs lock into place underneath the lift 40. The legs 10 angle away from the stand. It creates the perfect, comfortable and private changing station with plenty of space.

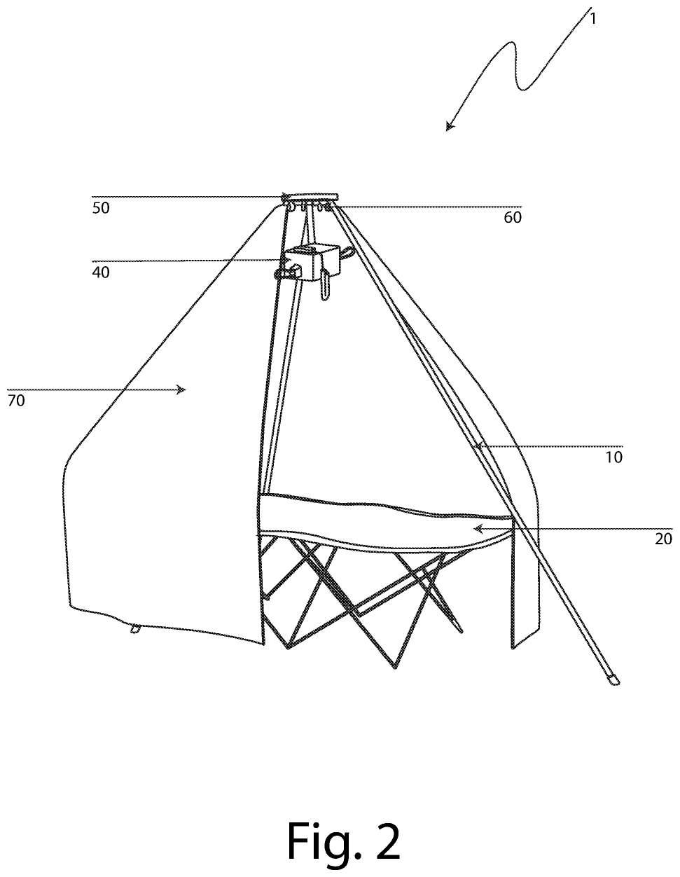

As shown in FIG. 2, the change station 1 has a privacy curtain 70. The curtain 70 attaches to the bottom of the tripod stand 50 and hangs over the legs 10 to provide privacy when changing the handicap person 100. The curtain 70 is attached to the bottom of the tripod stand 50 at the top of the curtain 70 through a connection means which in the preferred embodiment would be eyelets in the curtain 70 attached to a hook 60 or carabiner attached to the bottom of the tripod stand 50.

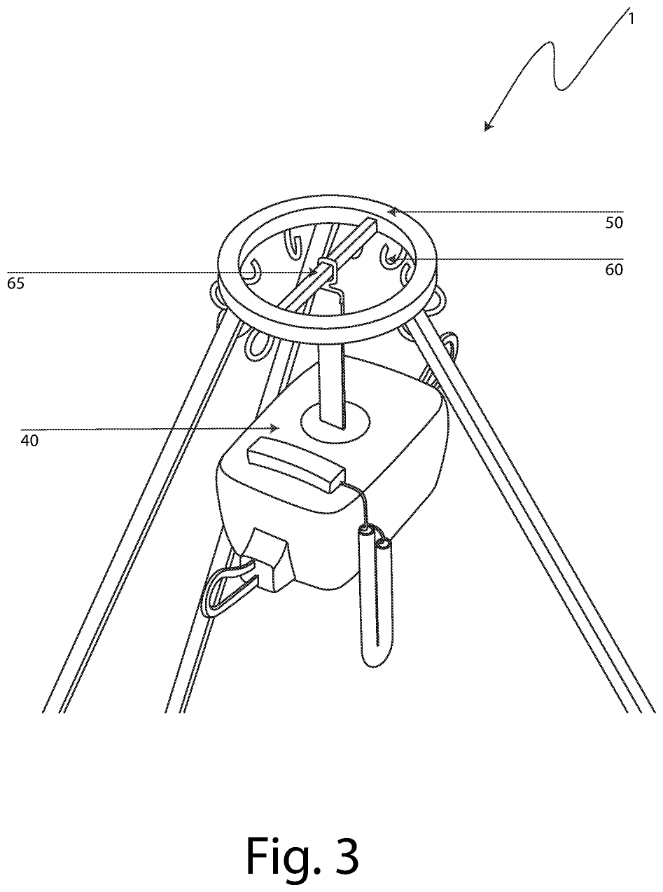

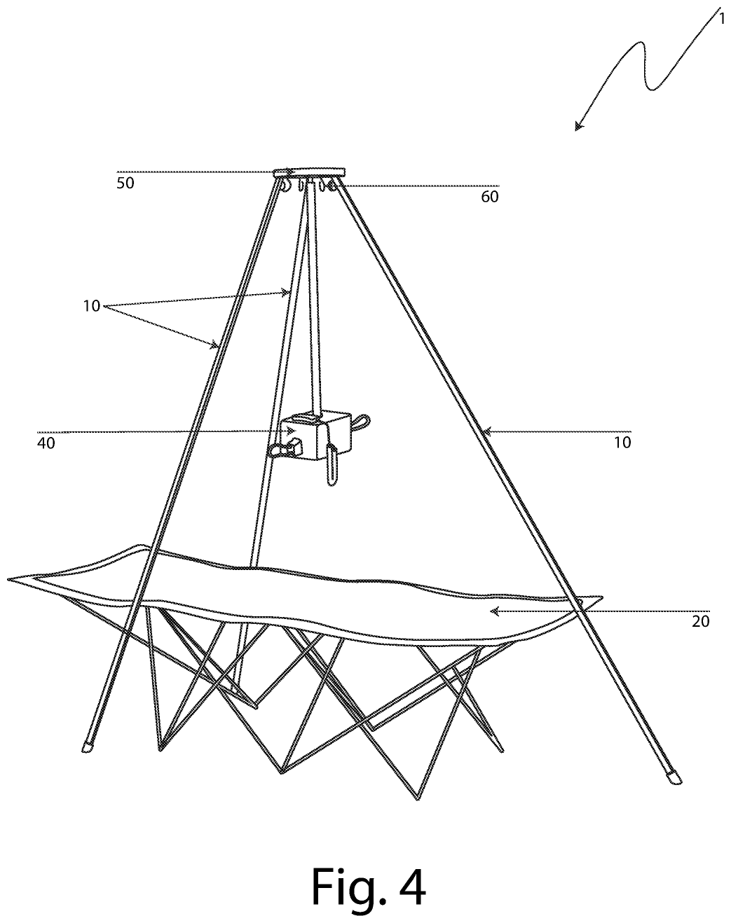

As shown in FIG. 3, the Hoyer lift 40 is attached to a base which can be a tripod stand 50 using a lift strap 43 with a metal loop 42 at the end. The metal loop 42 connects to a lift hook 60 or carabiners hanging down from the bottom of the tripod stand 50. FIG. 4 shows the lift 40 being lower into position to lift the handicapped individual 100.

A lift sling 25 would be placed flat on the table 20. The handicapped person 100 would be place on the sling 25. The side ends of the sling 25 would be attached to the lift brackets 41 which are on the opposite sides of the Hoyer lift 40 through an easy attachment means like carabiners. A belt or fastener would be placed around the person 100 to hold them in place. The Hoyer lift 40 would then be used to lift the person 100 up from the table 20 to be changed. The would be normally be done when the curtain 70 would be fully closed.

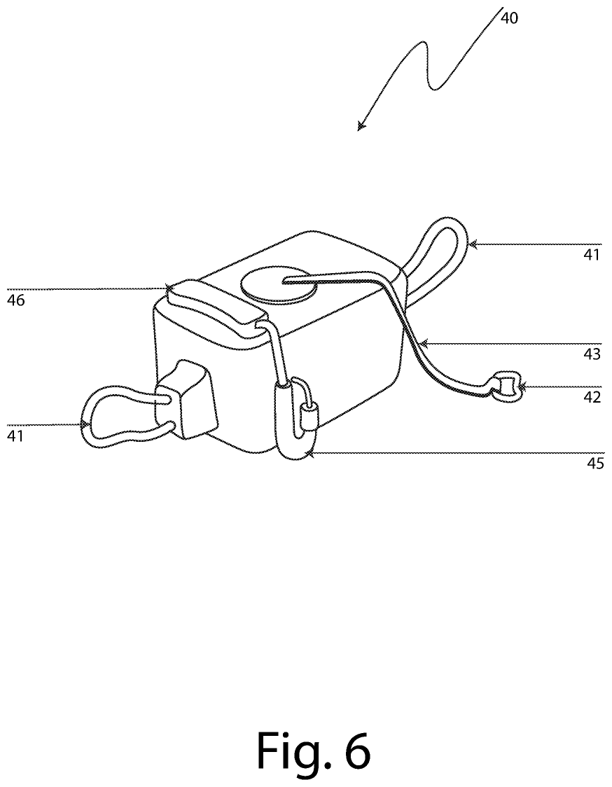

As shown in FIG. 6, the Hayden lift 40 would have lift brackets 41 on each side which could be carabiners. The Hayden lift 40 would have a lift strap 43 which extends out from the top of the lift 40. At the end of the lift strap 43 is the metal loop 42 which is used to attach the lift 40 to the tripod stand 50. The lift 40 will have a controller 46 which is used to direct the lift 40 to lower or raise. In the preferred embodiment, the controller 46 is attached to a cord 45 directly to the lift 40. The lift 40 will use hydraulics in the preferred embodiment, but can use electrical motors to move the lift 40 up and down by pulling in and extending the lift strap 43. The lift 40 would have a power source. The controller 46 can also be connected to the lift 40 using a wireless communication system.

All the components are compactly stored within the portable cart 90. The table 20 is folded up and placed in a table carry with a handle. The frame with the legs 10, ring 50 and cover 70 would be stored in another carry also with a handle. The table carry, carry and Hoyer lift 40 can be placed on the portable cart 90. The portable cart 90 a based with a handle that extends from the top with wheels at the bottom of the portable cart 90. The cart 90 has a shelf that extends out from the base on which the table carry, carry and Hoyer lift 40 are stored allowing for ease of movement. The cart 90 can be attached to the back of a wheel chair.

There are a number of significant design features and improvements incorporated within the invention. More than three legs can be used. The top of the changing station 1 can be squared or rectangular in shape. The legs can be folding or extending.

The privacy cover 70 is made of a light flexible material.

The legs 10 and the base 50 are made of a sturdy light weight material such as aluminum. The legs 10 may be able to fold or extend to reduce their footprint when stored.

### Advantages

The current invention meets an specific need of the handicap community and provides a collapsible table, adjustable lift, and privacy curtain. It works with a portable cart. It provides comfort, safety and convenience.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A changing station comprising:
a collapsible table, a lift attached to a base with a plurality of legs and a top and privacy curtain that connects to the top of the base and goes around the legs with a lift sling attached to said lift.

2. The changing system according to claim 1 further comprising:
Where the lift has a controller.

3. The changing system according to claim 1 further comprising:
a folding table.

4. The changing system according to claim 1 further comprising:
where there are three legs that fold out to form a tripod.

5. The changing system according to claim 1 further comprising:
where there legs are angled away from the base.

6. The changing system according to claim 1 further comprising:
where the lift is a Hoyer lift.

7. The changing system according to claim 1 further comprising:
where the privacy curtain is attached to the bottom of the base at the top of the privacy curtain through a connection means.

8. The changing system according to claim 7 further comprising:
where the connection means is eyelets in the privacy curtain attached to a carabiner attached to the bottom of the base.

9. The changing system according to claim 7 further comprising:
where the connection means is eyelets in the privacy curtain attached to a hook attached to the bottom of the base.

10. The changing system according to claim 1 further comprising:
where the lift is attached to the base using a lift strap with a metal loop where the metal loop connects to the bottom of the base.

11. The changing system according to claim 10 further comprising:
where the lift is attached to the base using a lift hook.

12. The changing system according to claim 10 further comprising:
where the lift is attached to the base using a carabiner.

13. The changing system according to claim 3 further comprising:
where the lift sling is placed on the table, an idea would be place in the lift sling and the lift would lift and lower the lift sling off the table.

14. The changing system according to claim 1 further comprising:
where the lift sling has sides where lift brackets would be attached to.

15. The changing system according to claim 1 further comprising:
where the lift sling has a belt or fastener.

16. The changing system according to claim 1 further comprising:
where the lift has lift brackets that connect to a plurality of lift straps.

17. The changing system according to claim 1 further comprising:
where the lift has a lift controller.

18. The changing system according to claim 17 further comprising:
where the lift controller is wireless.

19. The changing system according to claim 1 further comprising:
where the changing system is stored in a portable cart.

20. The changing system according to claim 1 further comprising:
where the legs extend.
